(19) United States
(12) Patent Application Publication
(10) Pub. No.: US 2003/0090622 A1
(43) Pub. Date: May 15, 2003

(54) Spectacle lens of glass-resin lamination and production of the same

(75) Inventor: Toshimichi Takeuchi, Nyu-gun (JP)

Correspondence Address: Ronald R. Snider, Snider & Associates, P.O. Box 27613, Washington, DC, 20038-7613, US

(73) Assignee: Japan Eyewear Corporation, Nyu-gun (JP)

(21) Appl. No.: 10/001,064

(22) Filed: Dec. 4, 2001

(30) Foreign Application Priority Data
Nov. 15, 2001 (JP) 2001-350160

(51) Int. Cl. G02C 7/02; H04B 10/00

(52) U.S. Cl. 351/159

(57) ABSTRACT

A spectacle lens, on the inner surface of which glass layer a synthetic resin layer is laminated, is provided, in more details, a high-performance spectacle lens of glass-resin lamination is provided together with its production method, the object side of which lens is made from an optical glass hard and less vulnerable to shape transformation while the ocular side of which lens is made from a transparent synthetic resin, which is easy to be ground and polished, so as to be provided with a refractive power as required for correcting a refraction or adjustment error of a particular individual's vision problem in an economical and a labor-saving manner.

Concretely speaking, a glass layer and a synthetic resin layer are integrally joined through the interposition of a thin buffering resin layer so as to prepare a see-through lens block, the object side of which block corresponds to the glass layer while the ocular side of which block corresponding to the synthetic resin layer, on which layer a curvature grinding and polishing operation is performed so as to be provided with a refractive power required for correcting a refractive error of a particular individual's vision.

### RELATED APPLICATION

The present application claims the priority of the Japanese Patent Application No.2001-350160 filed on Nov. 15, 2001, which prior application is incorporated herein by reference.

### BACKGROUND OF THE INVENTION

1. Technical Field

The present invention relates to spectacle lens, onto the inner side surface of which lens a synthetic resin lamination is layered, in more details, pertaining to a high performance spectacle lens of glass-resin lamination, the frontal object side of which lens is made from an optical glass hard and less vulnerable to shape transformation while the ocular side of which lens is made from a transparent synthetic resin easy to grind and polish so as to be provided with a corrective refractive power, on which synthetic resin grinding and polishing operation is performed to labor-savingly and inexpensively provide a prescription lens of various refractive indexes as required, which prescription lens opts for the correction of the ocular refraction or adjustment error, and the production method for the same lens.

2. Prior Art

As known, the ocular problems owing to the refraction or adjustment error of the human eyeballs include myopia wherein the parallel light rays passed through the lens with regard to the visual axis of the eyeball turn into an image before reaching the retina when the ciliary body is in a slack condition, hypermetropia wherein the parallel light rays passed through the lens with regard to the visual axis of the eyeball turn into an image behind the retina when the ciliary body slacks, astigmatism wherein the refractive power of the cornea of the eyeball is inconsistent between the latitudinal direction and longitudinal direction thereof so that an image is seen to be warped and presbyopia wherein the elasticity of the lens deteriorates owing to aging so as to weaken the power of vision to see the things nearby. In addition, the above ocular problems further include such cases as either myopia or hypermetropia being combined with not only astigmatism, but also presbyopia.

The myopia is corrected by using a concave lens of a minus (−) numerical degree to rectify the image turned out before the retina when it is seen with naked eyes so as to place the former onto the latter while the hypermetropia is corrected by using a convex lens of a plus (+) numerical degree to rectify the image turned out behind the retina when being seen with naked eyes so as to place the same image onto the retina. The astigmatism is corrected by using a cylinder lens that makes consistent the refractive power between the latitudinal and longitudinal directions of the cornea while either the myopia or hypermetropia being combined with the astigmatism is corrected by using a toric lens that is the combination of either the concave lens or the convex lens with the cylinder lens. In turn, the presbyopia is corrected by using a convex lens enabling the wearers to do such nearby work with the distance between approximately 25 to 33 cm away from the eyes as reading, writing and sewing.

Incidentally, the ready-made concave and convex lens for the myopia and the hypermetropia respectively are circulated in the general market, where they are supplied in such a manner that the minimum numerical indication thereof is set at 0.5 d and increases by 0.25 d, d of which is the abbreviation of dioptre signifying unit of refractive power when this is expressed as reciprocal (1/f) of focal length in meters and in front of which a minus (−) reference is prefixed for the concave lens while a plus (+) reference is prefixed for the convex lens. However, the spectacle lens as supplied to the market in such standardization as mentioned above allows the production cost thereof to be reduced indeed, but it often happens that such ready-made spectacle lens does not necessarily go well with a vision correction prescribed by the optician. For instance, assuming that the ideal diopter of the concave lens for the correction of someone's myopia is set at 0.85 d, the ready-made concave lens is available in the market only with the diopter of either 0.75 d or 1.00 d so that he/she has to compromise choosing the lens with one of them, with the result that he/she cannot obtain the vision correction as prescribed by the optician. In this case, it is usual that he/she is enforced to choose the lens with the larger dipoter (d) of the two so that he/she has to stand eyestrains thereafter, which implies that he/she has to accept the unreasonable situation where the eyes must be adjusted to the spectacles that they purchase.

On the other hand, the order-made spectacle lens dispenses with the above unreasonable situation. However, it costs very high to purchase the order-made spectacle lens. For instance, assuming that the spectacle lens of synthetic resin being order-made for someone, it requires a special casting die to mold a pair of lenses that just fit for him/her only, which die is very expensive to prepare. When he/she is suffering from anisometropia, it is needless to say that it increases the cost required for the preparation of such die.

The production of the spectacle lens made from optical glass through grinding and polishing operation does not require such casting die, so that it may be said that such lens can be obtained at a more reasonable price. However, on the contrary, the production cost thereof greatly increases, as it requires high-precision facility and high technology and takes time and labor for the production of the spectacle lens made from optical glass that just fits for a particular wearer only due to the hardness of the glass material. To make the matter worse, such spectacle lens of optical glass expensive to produce as mentioned above is extremely heavy to carry on the face.

### DISCLOSURE OF THE INVENTION

In view of the inconveniences encountered with the prior spectacle lens as mentioned above, the present invention is to provide a spectacle lens of glass-resin lamination in an order-made manner that just corresponds to a diopter (d) required for correcting the vision error of a particular individual, the price of which lens is rendered far more inexpensive than that of the prior order-made counterpart, and a method for producing the same lens.

Further, the present invention is to provide a spectacle lens of glass-resin lamination that weighs lighter than the spectacle lens of solely optical glass and is not subjected to deformation in shape or deterioration in quality during use in the same way as a plastic lens solely made from synthetic resin and a method for producing the same lens.

In addition, the present invention is to provide a spectacle lens of glass-resin lamination in a labor-saving and inexpensive manner that just corresponds to a diopter required for correcting the vision error of a particular individual, which lens is subjected to grinding and polishing operation by devices easy to operate, and a novel method for producing the same lens in a highly efficient manner.

The means adopted for solving the above issues are described below with reference to the accompanying drawings.

That is, the present invention is characterized in realizing a spectacle lens of glass-resin lamination, which lens is transparent to see through and comprises at least a glass layer 1 on the object side thereof and a synthetic resin layer 2 on the ocular side thereof, wherein the glass layer 1 and the synthetic resin layer 2 are integrally jointed through the interposition of a thin buffering resin layer 3 made from a transparent synthetic resin therebetween, on which resin layer 2 corresponding to the ocular side of the lens curvature grinding and polishing operation is performed so as to be provided with a refractive power enough to correct the refraction error of a particular individual's vision.

Then, the present invention is also characterized in realizing a method for producing a spectacle lens of glass-resin lamination possessed with a refractive power enough to correct the refraction error of a particular individual's vision, which method comprises the first step of either disposing an optical lens 1′ with a curvature on the outer surface thereof while with a transparent synthetic resin film 3′ attached on the inner surface thereof into a casting die D and injecting a casting resin R onto the resin film 3′ for solidification so as to obtain a transparent lens block B, which block is formed by integrally jointing a glass layer 1 and a synthetic resin layer 2 through the interposition of a buffering resin layer 3 or applying a transparent adhesive on the inner surface of the optical lens 1′ with a curvature on the outer surface thereof so as to bond a transparent synthetic resin plate 2′, which is molded into a shape fitting into the inner surface of the lens, onto the optical lens 1′ or attaching a transparent synthetic resin film 3′ onto the inner surface of the optical lens 1′, onto which resin film 3′ a transparent adhesive is applied so as to bond a transparent synthetic resin plate 2′ that is molded into a shape fitting into the inner surface of the lens onto the optical lens 1′, instead of the die-casting method as mentioned above, so as to obtain a transparent lens block B formed by integrally jointing a glass layer 1 and a synthetic resin 2 through the interposition of a buffering resin layer 3, and the second step of performing curvature grinding and polishing operation onto the synthetic resin layer 2 of any one of those lens blocks B as obtained so as to produce a spectacle lens of glass-resin lamination possessed with a refractive power enough to correct the refraction error of a particular individual's vision.

Then, the structural elements featuring the present invention are commented as follows.

1) The optical glass material to be used for the glass layer 1 corresponding to the object side of the spectacles lens according to the present invention includes such conventionally known glass as crown glass, flint glass or crown-flint glass. In this case, it is recommendable that the outer surface of the glass layer 1 to be prepared be convexly shaped. The thinner the glass layer becomes, the lighter the finished spectacle lens becomes, but the lens thickness in the order of 0.5 mm to 1.2 mm is enough for practical use.

2) When an optical glass plate, in a part of which a bi-focal portion 11 possessed with the function of a convex lens is integrally embedded, is adopted for the glass layer 1, it imparts a multi-focal function to the portion of the layer 1 so as to provide a spectacle lens uniform in section for both far and near-sightedness. Herein, the thickness of the glass layer 1 is defined within the range from 1.3 mm to 2.9 mm.

3) The synthetic resin layer 2 corresponding to the ocular side of the spectacle lens, which layer is made from a transparent synthetic resin plate produced by the injection molding of such synthetic resin material as thiol acrylate, thiol methacrylate, thiol urethane, brominated bisphenol and polycarbonate, maybe overlaid onto the inner surface of the glass layer 1 through the interposition of a buffering resin layer as mentioned below or be overlaid onto the glass layer 1 through the interposition of a buffering resin layer as described below by injecting a resin essentially consisting of diethylene glycol bis allyl carbonate into a casting die or onto a buffering resin layer.

4) The material for a buffering resin layer 3 includes a synthetic resin film made from such transparent and extensible synthetic resins as polyvinyl butyral and polyvinyl alcohol, which resin layer 3 may be not in the filmy state, but in the liquid form for application onto the inner surface of the glass layer 1. When any one of the above resins is overlaid onto the inner surface of the glass layer 1 in the filmy state, any one of urethane primer, nitrile rubber adhesives or epoxy resin adhesives that are of transparent liquid form is applied thereon for adhesion.

5) The means to provide the refractive power required for the synthetic resin layer 2 corresponding to the ocular side of the lens block B include a rough machining device to retain the lens block B from rotating and to generate curvature on the surface of the synthetic resin 2 by three-dimensionally moving a grinding tool or driving the same tool towards the X, Y and Z directions in the space under numerical control and a buffing machine to finish the roughly ground surface of the synthetic resin 2 into a smooth curvature by rubbing and polishing the ground surface with a buff together with a polishing liquid.

### BRIEF DESCRIPTION OF THE DRAWINGS

FIG. 1 is a procedural illustration to show the step of applying an adhesive onto the inner surface of an optical glass wafer according to the first embodiment of the present invention.

FIG. 2 is a procedural illustration to show the step of jointing a transparent synthetic resin plate onto the optical glass according to the first embodiment of the present invention.

FIG. 3 is a sectional view of an intermediately worked lens block according to the first embodiment of the present invention.

FIG. 4 is a procedural illustration to show the step of arranging the intermediately worked lens block onto the receptacle of the rough machining device so as to roughly grind the surface of the same block with a grinding tool according to the first embodiment.

FIG. 5 is a procedural illustration to show the step of arranging the lens block, onto which rough machining operation has been performed, onto the buffing machine so as to perform finishing and polishing operation on the roughly ground block according to the first embodiment.

FIG. 6 is a sectional view to show a spectacle lens of glass-resin lamination produced according to the first embodiment.

FIG. 7 is a procedural illustration to show the step of applying an adhesive onto the inner surface of the optical glass wafer so as to attach a transparent synthetic resin film thereon according to the second embodiment.

FIG. 8 is a procedural illustration to show the step of applying an adhesive onto the film attached on the inner surface of the optical glass wafer so as to joint a transparent synthetic resin plate thereon according to the second embodiment.

FIG. 9 is a sectional view of an intermediately worked lens block according to the second embodiment.

FIG. 10 is a procedural illustration to show the step of arranging the intermediately worked lens block onto the receptacle of the rough machining device so as to roughly grind the surface of the same block with a grinding tool according to the second embodiment.

FIG. 11 is a broken perspective view of a casting die to be used in the third embodiment, which view shows the state where the optical glass wafer is arranged into the same die.

FIG. 12 is a procedural illustration to show the step of injecting a resin into the casting die according to the third embodiment.

FIG. 13 is a sectional view of an intermediately worked lens block according to the third embodiment.

### BEST MODE FOR CARRYING OUT THE INVENTION

Hereafter, the preferred embodiments of the present invention are in more details described with reference to the accompanying drawings.

(First Embodiment)

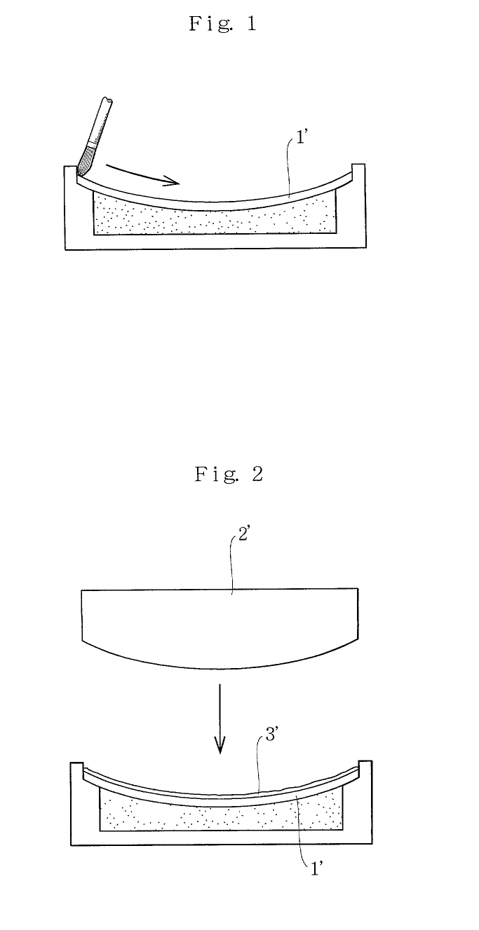

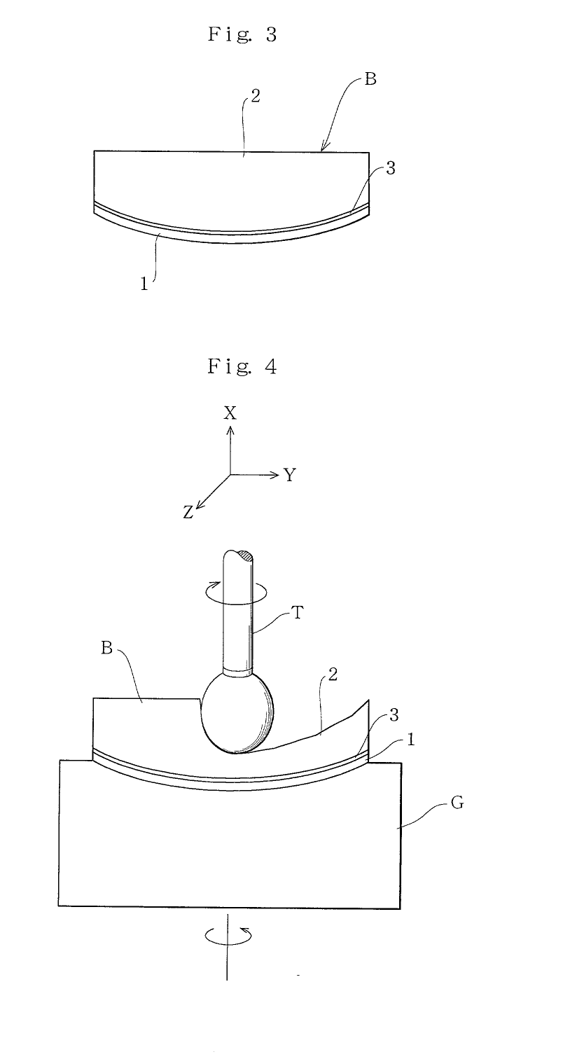

FIGS. 1 through 7 show the steps of producing a spectacle lens of glass-resin lamination according to the present embodiment. Reference number 1′ in FIGS. 1 and 2 indicates a wafer of crown-flint optical glass having 0.5 mm in thickness, the outer side of which wafer is convexly shaped while the inner side of which is concavely shaped. An adhesive essentially consisting of polyvinyl butyral is applied onto the inner surface of the wafer 1′, onto which a transparent synthetic resin plate 2′, which plate is produced by the injection molding of thiol acrylate resin and the circumferential portion of which has 10 mm in thickness and the central portion of which has 15 mm in thickness, and the outer surface of which plate is convexly shaped while the inner surface of which plate is flat in shape, is overlaid. Herein, the inner concave surface of the wafer 1′, on which the adhesive is applied, is arranged to have the same curvature as that of the outer convex surface of the synthetic resin plate 2′, so that the wafer 1′ and the resin plate 2′ just correspond to each other through the interposition of the adhesive therebetween. Then, the solidification of the adhesive allows a transparent buffering resin layer 3 consisting of polyvinyl butyral resin having 0.05 mm in thickness to be generated, together with which resin layer 3 an optical glass layer 1 and a synthetic resin layer 2 form a transparent lens block B having 70 mm in diameter as shown in FIG. 3, the circumferential portion of which block has 11.05 mm in thickness and the central portion of which block has 15.55 mm in thickness.

The finished lens blocks B are warehoused in storage, which blocks are set onto a receptacle G of a rough machining device provided with a grinding tool T as shown in FIG. 4, which device operates under numerical control, upon receiving an order from a customer, so as to provide a refractive power or dipoter (d) required for correcting his/her vision error. A small diamond point is provided at the tip end portion of the grinding tool T, which tool operates at 32,000 rpm and three-dimensionally moves with precision with regard to the X, Y and Z directions in the space, whereas the receptacle G slowly rotates of the order of two revolutions per minute.

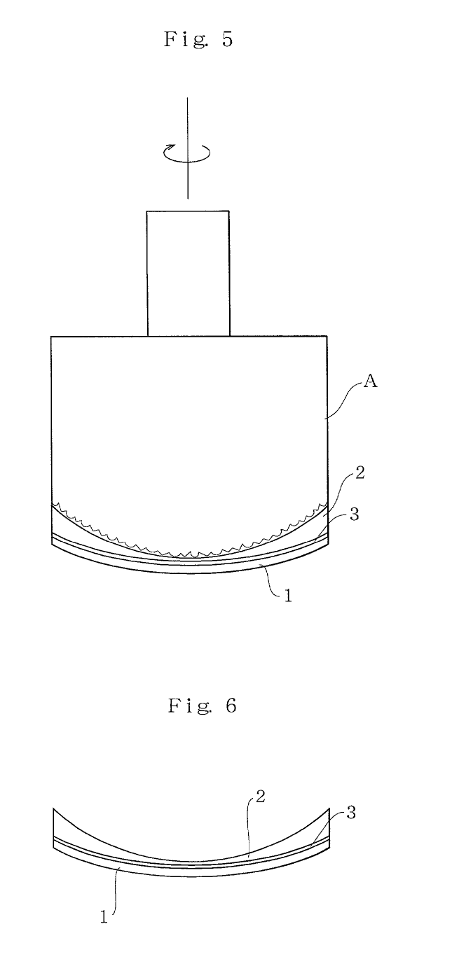

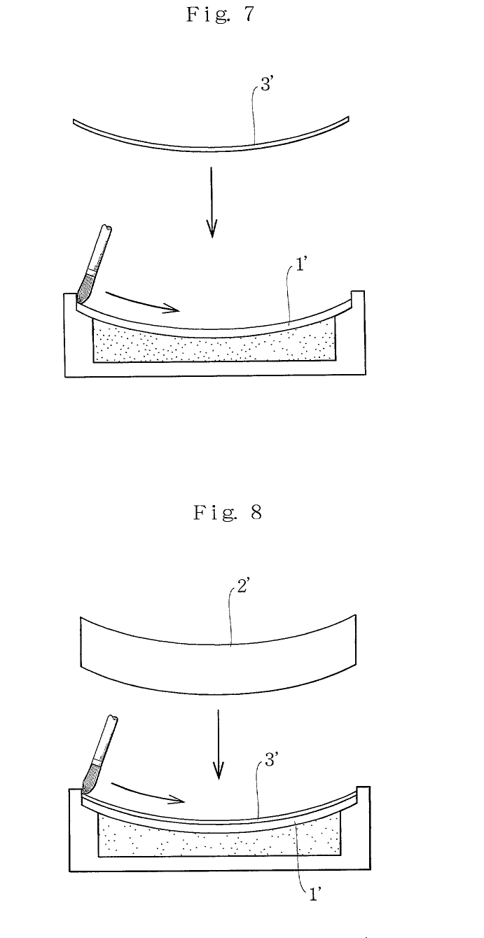

Finishing and polishing operation is performed by a buffing machine A on a roughly finished lens block B comprising three layers 1, 2 and 3. A polishing portion of the buffing machine A is provided with a buff to finely grind and polish the inner surface of the roughly finished synthetic resin layer 2, which buff polishes the said inner surface with a polishing liquid, which is not shown in the drawings, applied thereto so as to finish said surface into a smooth curvature as shown in FIG. 5. At the completion of the finishing operation, a spectacle lens is removed from the buffing machine A and subjected to ultrasonication for washing inside a neutral detergent solution, which results in a spectacle lens of glass-resin lamination excellent in transparency as shown in FIG. 6. The finished spectacle lens, which has 70 mm in diameter and the circumferential portion of which lens has 10.8 mm in thickness while the central portion of which lens has 7.5 mm in thickness, is mounted into the respective rims of a spectacle frame, which frame is not shown in the drawings, as a prescription lens for myopia at the customer's disposal.

It should be noted that the spectacle lens of glass-resin lamination as shown in FIG. 6 has a ground and polished curvature intended for the spectacle lens for myopia, which is only one example of the first embodiment putting to use a rough machining device to three-dimensionally operate a grinding tool T with precision under numerical control, and rough machining operation can be labor-savingly and easily carried out for a convex lens for hypermetropia or presbyopia, a cylinder lens for astigmatism, a toric lens to correct the refraction error caused by the combination of either myopia or hypermetropia with astigmatism, a progressive power lens or bi-focal lens for both far and near-sightedness according to the inputting of the varied control numerals.

(Second Embodiment)

Numerical reference 1′ in FIGS. 7 and 8 indicates a wafer of a crown-flint optical glass, which wafer has 70 mm in diameter and 0.8 mm in thickness while the outer surface of which wafer is convexly shaped. In this embodiment, an adhesive essentially consisting of polyvinyl butyral is applied onto the inner surface of the wafer 1′, on which a film 3′ with 0.2 mm in thickness made from polyvinyl alcohol resin is overlaid as shown in FIG. 8.

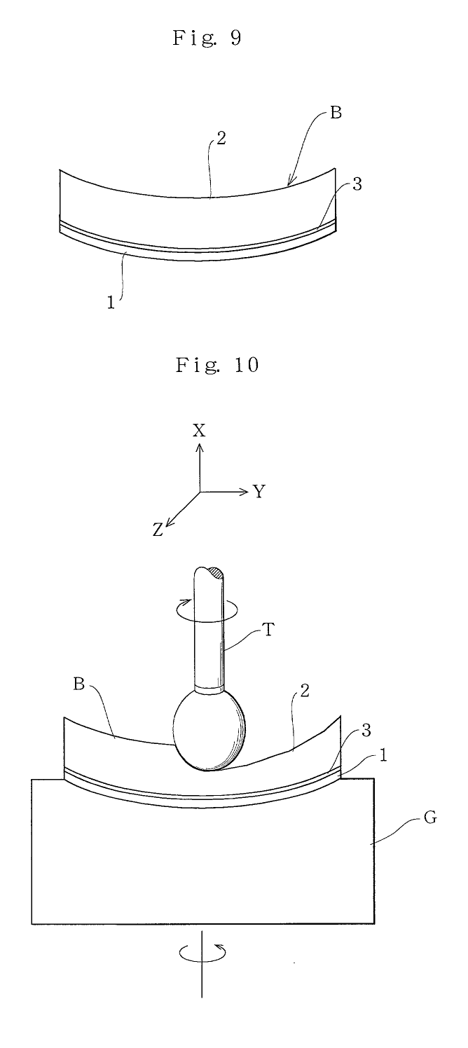

Then, the polyvinyl butyral adhesive is applied onto the upper surface of the polyvinyl alcohol resin film 3′ that is attached onto the wafer 1′, on which upper surface a curved transparent synthetic resin plate 2′ obtained by the injection molding of polycarbonate resin, the circumferential portion of which plate has 12 mm in thickness and the central portion of which plate has 12 mm in thickness while the outer surface of which plate is convexly shaped and the inner surface of which plate is concavely shaped, is overlaid for adhesion. This results in a curved lens block B having 70 mm in diameter and uniformly having 13.02 mm in thickness as shown in FIG. 9. Herein, in the same way as the first embedment, the inner surface of the wafer 1′ on which the film 3′ is attached has the same curvature as that of the outer surface of the synthetic resin plate 2′, so that there occurs any interstice between the opposed adhering surfaces thereof.

The resulting lens block B is arranged into the receptacle G of a rough machining device for the precise curving operation by the grinding tool T under numerical control so as to be provided with a curvature having a refractive index required for correcting the vision error of a client as shown in FIG. 10. The spectacle lens provided with a required curvature through the rough machining operation is arranged onto the buffing machine in the same way as the first embodiment for the finishing and polishing operation thereof, which lens is then subjected to washing treatment for the last step. The finished spectacle lens of glass-resin lamination possessed with the function of a concave lens, which lens has 70 mm in diameter while the circumferential portion of which lens has 12 mm in thickness and the central portion of which lens has 7 mm in thickness, is at the client's disposal for correcting myopia. The present embodiment is the same as the first embodiment in that a convex lens for either hypermetropia or presbyopia, a cylinder lens for astigmatism, a toric lens for correcting the refraction error caused by the combination of either myopia or hypermetropia with astigmatism, a progressive power lens or bi-focal lens for far and near-sightedness are also producible, besides the concave lens as exemplified above.

(Third Embodiment)

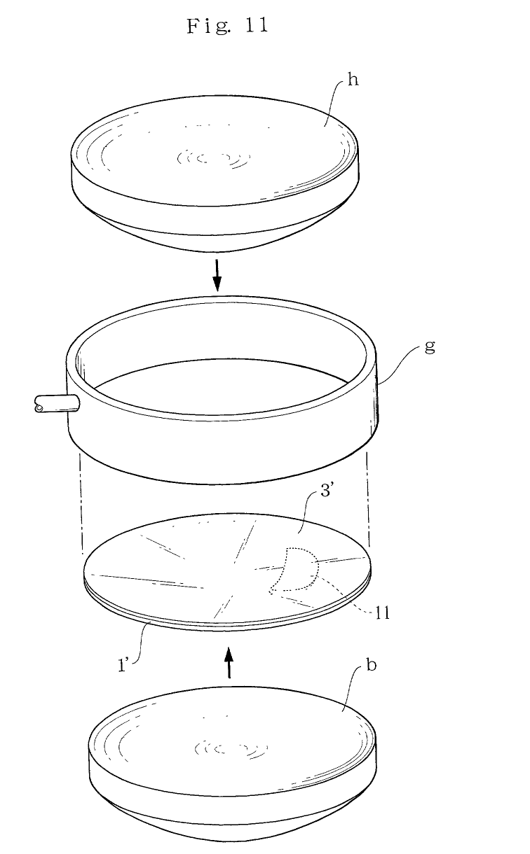

As shown in FIG. 11, a casting die D is constituted by mounting a disk-like upper die h, the lower surface of which die is convexly shaped, into the upper inner fringe of a cylindrical gasket g provided with a molding cavity therein and mounting a disk-like lower die b, the upper surface of which die is concavely shaped, into the lower inner fringe of the gasket. A molding space, into which a casting resin is injected, is generated between the upper and lower dies.

In the present embodiment, a wafer 1′ of crown glass, which wafer has 70 mm in diameter and has 2.9 mm in thickness while in the vicinity of the circumferential fringe of which wafer a bi-focal portion 11 possessed with the function of a convex lens and having the diopter of 4 d is integrally embedded, is prepared by applying an adhesive essentially consisting of polyvinyl butyral resin onto the inner concave surface thereof, on which a film 3′ that is made from polyvinyl butyral resin and has 0.4 mm in thickness is attached. The wafer as prepared this way is arranged inside the casting die D by mounting the lower die b, on which the wafer is mounted, into the lower inner fringe of the gasket g.

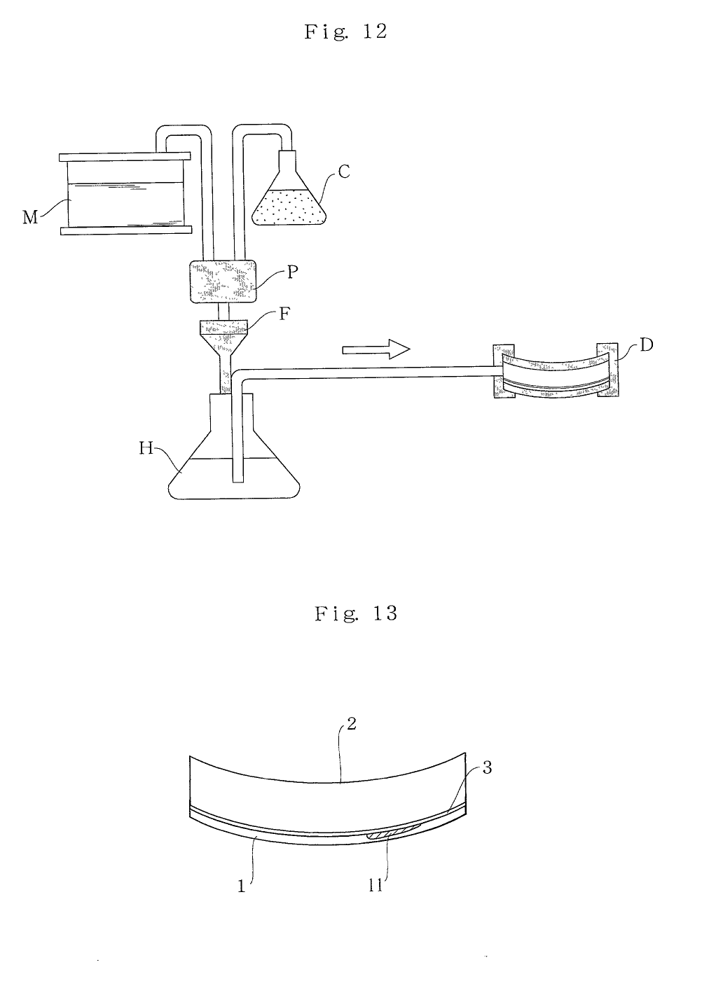

In FIG. 12, references M, C, P, F and H indicate a monomer tank, a catalyst tank, a mixer, a filter and a hopper to receive a casting resin therein, respectively. This hopper H is engaged to the casting die D through a pipe and allows a casting resin to be injected into the molding space of the die D under the application of a certain pressure.

In the present embodiment, diethylene glycol bis allyl carbonate is contained in the monomer tank M while in the catalyst tank C benzoyl peroxide is contained as an initiator of radical polymerization, both of which are proportionally mixed together in the mixer P so as to compose a casting resin, which resin passes through the filter F so as to be received in the hopper H. Then, the casting resin as contained in the hopper H is injected into the molding space of the die D.

The resin injected into the molding space of the casting die D is maintained therein for two to eight hours at the temperature of 30 to 45° C. for initial polymerization, and is heated up to 80 to 100° C. during 10 to 50 hours for polymerization at the progress of the initial polymerization. At this stage, inside the casting die D, a transparent lens block B is formed through the interposition of a buffering transparent resin layer 3 between an optical glass 1 and a synthetic resin layer 2. At the completion of the polymerization, the lens block B is removed from the gasket g, on which block washing treatment is performed so as to generate a curved disk-like lens block B as shown in FIG. 13. The lens block B die-cast according to the present embodiment has 70 mm in diameter and 14.9 mm in thickness.

The rough machining and buffing operations are performed on the resulting lens block B in the same way as the first and second embodiments, which turns the lens block B into a spectacle lens of glass-resin lamination for both far and near-sightedness wherein the portions of the lens excepting the bi-focal portion 11 thereof play the role of the convex lens for hypermetropia while the bi-focal portion plays the role of the convex lens for presbyopia. The explanation of the rough machining and buffing operations performed on the lens is omitted for avoiding the redundancy of the description.

(Modifications)

The preferred embodiments of the present invention have been substantially disclosed above, to which embodiments this invention is not limited, but it can be modified into various manners within the scope of the accompanying patent claims. It should be appreciated that any of the following modifications belongs to the technical scope of the present invention.

1) In the above embodiments, crown glass and crown-flint glass are only exemplified for the optical glass forming the glass layer 1, which optical glass may perform various functions in such a manner that various elements including such rare metal as neodymium that are unable to be mixed with a synthetic resin lens or compounds hazardous to our health are mixed with such optical glass as mentioned above.

2) In the above embodiments, colorless or transparent materials are adopted for a synthetic resin material forming the synthetic resin layer 2 corresponding to the ocular side of the spectacle lens of glass-resin lamination, with which resin material pigments may be mixed so as to be colored or to be provided with photograying function or photochromics may be mixed so as to be provided with a function to momentarily change colors according to the incident light wavelengths or ultraviolet or infrared rays absorbing materials may be mixed so as to be provided with a function to remove hazardous rays from the incident light.

3) In the above embodiments, a completely colorless or transparent synthetic resin film is exemplified for a material forming a buffering transparent resin layer 3, which film may be not completely colorless, but be transparent enough to be able to see through and be such as a polarized film or a film containing infrared or ultraviolet rays absorbing materials. The overlay of a synthetic resin layer 2 containing a ultraviolet rays absorbing material onto a film forming the buffering transparent resin layer 3, which film contains an infrared rays absorbing material, allows a spectacle lens to remove both ultraviolet and infrared rays from the incident light.

4) The mixture of each material having different function with the glass layer 1, the synthetic resin layer 2 and the buffering transparent resin layer 3 respectively brings complimentary or synergistic effect on the spectacle lens of glass-resin lamination so as to permit the same lens to be provided with the unique functions that the conventional spectacle lens made from the sole composition has been unable to possess.

As described above, the present invention allows a spectacle lens of glass-resin lamination that just corresponds to the diopter (d) required for correcting the vision error of a particular individual to be supplied in an order-made fashion far more inexpensively than the conventional order-made counterpart, which completely resolves the misalignment between the prescribed lens and the actual eyes in question so as to provide the eyestrains sufferers troubling with such misalignment with an ideal spectacle lens.

The spectacle lens of glass-resin lamination according to the present invention weighs lighter than the conventional lens solely made from an optical glass and is hard to be scratched on the outer surface thereof in comparison with the plastic lens solely made from synthetic resin. Further, the buffering resin layer interposes between the glass layer and the synthetic resin layer, so that even if it experienced with such hysteresis as temperature change, this buffering layer absorbs the difference in expansion between the glass layer and the synthetic layer so as to prevent the slippage between the layers from peeling them off, with the result that the spectacle lens according to the present invention excels in both durability and quality stability.

The production method of the spectacle lens of glass-resin lamination according to the present invention requires machines simple in structure for performing rough machining and buffing operations so as to allow a spectacle lens of glass-resin lamination that just corresponds to the diopter for correcting the vision error of a particular individual to be inexpensively supplied to him/her with ease and high efficiency.

In view of the foregoing or economically and practically speaking, the industrial applicability of the present invention is very high, as the present invention resolves a number of the inconveniences encountered with the prior spectacle lens, which does not lead to large increase of equipment cost for working this invention.

1. A spectacle lens of glass-resin lamination comprising at least a glass layer 1 at an object side thereof and a synthetic resin layer 2 at an ocular side thereof wherein said glass layer 1 and said synthetic resin layer 2 are integrally joined through an interposition of a thin buffering resin layer 3 made from a transparent synthetic resin and a curvature grinding and polishing operation is performed on said synthetic resin layer 2 at the ocular side of said spectacle lens so as to be provided with a refractive power required for correcting a refractive vision error of a particular individual.

2. A spectacle lens of glass-resin lamination according to claim 1 wherein said glass layer 1 is made from an optical glass plate 1′ having a convex curvature on an outer surface thereof and said synthetic resin layer 2 is integrally jointed with said glass layer 1 through an interposition of a transparent synthetic resin film 3′ to form the buffering resin layer 3, which film is attached on an inner surface of said optical glass plate 1′, by die-casting said resin layer 2 on said resin film 3′.

3. A spectacle lens of glass-resin lamination according to claim 1 wherein the glass layer 1 is made from an optical glass plate, in a part of which plate a bi-focal portion 11 possessed with a convex lens function is embedded.

4. A spectacle lens of glass-resin lamination in any one of the preceding claims wherein the glass layer 1 is made from an optical glass plate having a curvature on an outer surface thereof while the synthetic resin layer 2 is made from a transparent synthetic resin plate shaped such that it fits into an inner surface of said glass layer 1, and said transparent synthetic resin plate and said glass plate are integrally joined through an interposition of a transparent synthetic resin film so as to form a stratum comprising the glass layer 1, the buffering resin layer 3 and the synthetic resin layer 2.

5. Method for producing a spectacle lens of glass-resin lamination comprising the steps of applying a transparent adhesive onto an inner surface of an optical lens 1′ having a curvature on an outer surface thereof and adhering a transparent synthetic resin plate 2′, which plate is shaped such that it fits into said inner surface, onto said inner surface so as to obtain a see-through lens block B arranged such that a glass layer 1 and a synthetic resin layer 2 are integrally joined through an interposition of a buffering resin layer 3; and performing a curvature grinding and polishing operation on said synthetic resin layer 2 so as to be provided with a refractive power required for correcting a refractive error of a particular individual's vision.

6. Method for producing a spectacle lens of glass-resin lamination comprising the steps of attaching a transparent synthetic resin film 3′ onto an inner surface of an optical lens 1′ having a curvature on an outer surface thereof and applying a transparent adhesive onto said synthetic resin film 3′ so as to adhere a transparent synthetic resin plate 2′, which plate is shaped such that it fits into said inner surface, onto said resin film 3′ so as to obtain a see-through lens block B arranged such that a glass layer 1 and a synthetic resin layer 2 are integrally joined through an interposition of a buffering resin layer 3; and performing a curvature grinding and polishing operation on said synthetic resin layer 2 so as to be provided with a refractive power required for correcting a refractive error of a particular individual's vision.

7. Method for producing a spectacle lens of glass-resin lamination comprising the steps of disposing an optical lens 1′ having a curvature on an outer surface thereof, on an inner surface of which lens a transparent synthetic resin film 3′ is attached, into a casting die D; injecting a casting resin onto said synthetic film 3′ and solidifying said resin so as to obtain a see-through lens block B arranged such that a glass layer 1 and a synthetic resin layer 2 are integrally joined through an interposition of a buffering resin layer 3; and performing a curvature grinding and polishing operation on said synthetic resin layer 2 so as to be provided with a refractive power required for correcting a refractive error of a particular individual's vision.
